(19) United States
(12) Patent Application Publication
(10) Pub. No.: US 2026/0168465 A1
(43) Pub. Date: Jun. 18, 2026

(54) NOZZLE PLUGS AND ASSOCIATED NOZZLES ASSEMBLIES AND METHODS

(71) Applicant: Northrop Grumman Systems Corporation, Falls Church, VA (US)

(72) Inventors: Daniel Lewis Cowan, West Jordan, UT (US); Andrew Lee Thompson, Los Angeles, CA (US)

(21) Appl. No.: 18/978,097

(22) Filed: Dec. 12, 2024

(51) Int. Cl. F02K 9/97; B05B 15/16

(52) U.S. Cl. CPC F02K 9/978; B05B 15/16

(57) ABSTRACT

A nozzle plug includes a first lateral structure in a first lateral plane, the first lateral structure includes a first set of openings defined in the first lateral structure. The nozzle plug further includes a second lateral structure in a second lateral plane vertically offset from and parallel to the first lateral plane, the second lateral structure includes a second set of openings defined in the second lateral structure, the second set of openings laterally offset from the first set of openings. The nozzle plug also includes a lattice structure positioned between the first lateral plane and the second lateral plane.

### TECHNICAL FIELD

Embodiments of this disclosure generally relate to nozzle plugs. In particular, embodiments of the disclosure relate to nozzle plugs and associated nozzle assemblies and methods.

### BACKGROUND

Nozzles are used to direct energy produced by combusting fuel in a motor, such as a rocket motor, to create thrust and cause an associated vehicle to move. Motors that utilize nozzles conventionally include a fuel source attached directly to the nozzle. Exposure of the fuel to the surrounding elements, such as water or debris, may reduce the effectiveness of the fuel and/or may make it difficult to start a combustion process. For example, in some cases, a rocket motor may have a launch initiated under water. If the water comes in contact with the fuel, the water may reduce the effectiveness of the combustion process or even prevent the combustion process from starting.

To prevent this, nozzle plugs may be inserted into the nozzle of a motor. The nozzle plug may substantially prevent contaminants, such as water or debris, from reaching the fuel. The nozzle plugs may remain in the nozzle of the motor until the combustion process is initiated. Upon initiation of the combustion process, the thrust generated by the motor may eject the nozzle plug. With the nozzle plug ejected, the thrust generated by the motor may then cause the associated vehicle to accelerate in the desired direction, as directed by the nozzle.

### BRIEF SUMMARY

Embodiments of the disclosure include a nozzle plug. The nozzle plug includes a first lateral structure in a first lateral plane, the first lateral structure includes a first set of openings defined in the first lateral structure. The nozzle plug further includes a second lateral structure in a second lateral plane vertically offset from and parallel to the first lateral plane, the second lateral structure includes a second set of openings defined in the second lateral structure, the second set of openings laterally offset from the first set of openings. The nozzle plug also includes a lattice structure positioned between the first lateral plane and the second lateral plane.

Another embodiment of the disclosure includes a method of forming a nozzle plug. The method includes forming a first lateral structure includes a first planar structure including a first plurality of openings defined in the first lateral structure. The method further includes forming a lattice structure over the first lateral structure, the lattice structure including lattice trusses extending at an angle relative to the first lateral structure, where each lattice truss extends from an opening of the first plurality of openings defined in the first lateral structure. The method also includes forming a second lateral structure over the first lateral structure, the second lateral structure includes a second planar structure including a second plurality of openings, where each opening of the second plurality of openings is joined to at least one lattice truss of the lattice trusses of the lattice structure.

Other embodiments include a nozzle assembly. The assembly includes a nozzle exit cone and a nozzle plug disposed in the nozzle exit cone. The nozzle plug includes a lattice structure including intersecting lattice trusses. The nozzle plug further includes a first lateral structure including a first plurality of openings defined in the lateral structure, each opening of the first plurality of openings in the lateral structure positioned at an intersection between at least two lattice trusses of the intersecting lattice trusses of the lattice structure

### BRIEF DESCRIPTION OF THE DRAWINGS

While the specification concludes with claims particularly pointing out and distinctly claiming embodiments of the disclosure, the advantages of embodiments of the disclosure may be more readily ascertained from the following description of embodiments of the disclosure when read in conjunction with the accompanying drawings in which:

FIG. 1 illustrates a schematic view of a nozzle assembly in accordance with embodiments of the disclosure;

FIG. 2 illustrates a side view of a nozzle plug in accordance with embodiments of the disclosure;

FIG. 3 illustrates a perspective view of the nozzle plug of FIG. 2;

FIG. 4 illustrates a top-down view of the nozzle plug of FIGS. 2 and 3;

FIG. 5 illustrates a schematic view of internal structures of a nozzle plug in accordance with embodiments of the disclosure;

FIG. 6 illustrates a cross-sectional view of the nozzle plug of FIGS. 2-4;

FIG. 7 illustrates an enlarged view of the cross-sectional view of the nozzle plug of FIG. 6;

FIG. 8 illustrates a cross-sectional view of a segment of a nozzle plug in accordance with embodiments of the disclosure; and

FIG. 9 illustrates a flow chart representative of a method of forming a nozzle plug in accordance with embodiments of the disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional fabrication techniques employed in the industry. Only those process acts and structures necessary to understand the embodiments of the disclosure are described in detail below.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the terms “configured” and “configuration” refers to a size, a shape, a material composition, a material distribution, orientation, and arrangement of at least one feature (e.g. one or more of at least one structure, at least one material, at least one region, at least one device) facilitating use of the at least one feature in a pre-determined way.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the term “and/or” means and includes any and all combinations of one or more of the associated listed items.

As used herein, the terms “vertical,” “longitudinal,” “horizontal,” and “lateral” are in reference to a major plane of a structure and are not necessarily defined by earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure. With reference to the drawings, a “horizontal” or “lateral” direction may be perpendicular to an indicated “Z” axis, and may be parallel to an indicated “X” axis and/or parallel to an indicated “Y” axis; and a “vertical” or “longitudinal” direction may be parallel to an indicated “Z” axis, may be perpendicular to an indicated “X” axis, and may be perpendicular to an indicated “Y” axis.

As discussed above, exposure of the fuel in a vehicle or motor utilizing a nozzle to the surrounding elements, such as water or debris, may reduce the effectiveness of the fuel and/or may make it difficult to start a combustion process. This may be exacerbated by vehicles used in or around bodies of water, such as a lake, river, or ocean. If the water comes into contact with the fuel, the water may reduce the effectiveness of the combustion process or even prevent the combustion process from starting. Nozzle plugs may be inserted into the nozzle of a motor. The nozzle plug may substantially prevent contaminants, such as water or debris, from reaching the fuel. The nozzle plugs may remain in the nozzle of the motor until the combustion process is initiated. Upon initiation of the combustion process, the thrust generated by the motor may eject the nozzle plug. With the nozzle plug ejected, the thrust generated by the motor may then cause the associated vehicle to accelerate in the desired direction, as directed by the nozzle.

Because the nozzle plugs are ejected, they may cause damage or injuries to surrounding equipment, buildings, or personnel. Some nozzle plugs may cause damage to the nozzle or associated motor during launch by blocking air from passing through the nozzle plug. For example, when a rocket is launched from a launching tube, such as from a launching tube in a submarine or a launching tube on a ship, the rocket may be initially ejected from the launching tube with a sudden increase in pressure in the launching tube before the motor is started to avoid damaging the launching tube and associated structure or vehicle. If the nozzle plug does not allow sufficient air to pass through the nozzle plug, the pressure differential may cause the plug to damage one or more components of the rocket. Some nozzle plugs may be formed from porous materials, such as reticulated aluminum. The porous materials may facilitate air passage, however, the pores in the material are not uniform and lack the control to accurately block passage of contaminants. Embodiments of the disclosure are directed to light-weight nozzle plugs configured to block liquid and solid contaminants from passing therethrough while facilitating the passage of air through the nozzle plugs. The nozzle plugs of the disclosure may facilitate improved control of the combustion process in an associated motor when launched near or in a body of water as well as protecting the fuel of the associated motor during transportation.

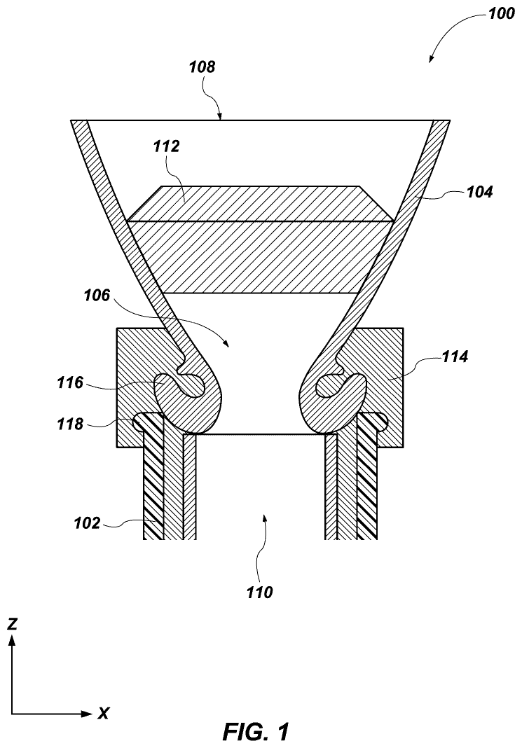

FIG. 1 illustrates a nozzle assembly 100 attached to a vehicle 102, such as a rocket, spacecraft, missile, aircraft, etc. The nozzle assembly 100 includes a exit cone 104 extending from a throat 106 to an opening 108. A fuel 110 may be stored in the vehicle 102 on an opposite side of the throat 106 from the opening 108. Thus, exhaust byproducts from combustion of the fuel 110 may be accelerated through the throat 106 and directed out the opening 108 by the nozzle assembly 100. The nozzle assembly 100 is coupled to the vehicle 102 through a coupler 114 configured to capture a securing element 116 of the nozzle assembly 100 and a securing element 118 of the vehicle 102. The coupler 114 may be configured to secure the nozzle assembly 100 relative to the vehicle 102 and form a seal between the vehicle 102 and the nozzle assembly 100. The seal formed by the coupler 114 may maintain the control of the combustion process and the exhaust of the byproducts, such that all of the byproducts of the combustion process are exhausted through the throat 106 and subsequently through the opening 108 of the nozzle assembly 100. This may direct the thrust generated by the exhaust of the byproducts of the combustion process in the desired direction through the nozzle assembly 100. The seal may also substantially prevent the ingress of contaminants into the fuel 110 by forming a substantially liquid-and air-tight seal between the nozzle assembly 100 and the vehicle 102.

When the fuel is not burning, the opening 108 of the nozzle assembly 100 may be the only path for contaminants, such as water or debris, to pass through the nozzle assembly 100 and reach the fuel 110. As discussed above, the ingress of contaminants is undesirable and may negatively affect the fuel and/or a subsequent combustion. In the embodiment illustrated in FIG. 1, a nozzle plug 112 is positioned in the nozzle assembly 100 in the area defined by the exit cone 104. The exit cone 104 may have a frustoconical shape increasing in diameter at greater distances from the throat 106. The nozzle plug 112 may have a complementary frustoconical shape configured to substantially match contours of the exit cone 104 and seat or seal against the inner surface of the exit cone 104 in an area before the throat 106.

The nozzle plug 112 may be configured to control the ingress and egress of materials through the opening 108. For example, the nozzle plug 112 may be porous, such that some materials may pass through the nozzle plug 112 while other materials are filtered out by the size of the pores in the plug. The pores may be sized and arranged such that surface tension in liquid materials may substantially prevent the liquid materials from passing through the pores in the nozzle plug 112.

With the nozzle plug 112 installed in the exit cone 104 of the nozzle assembly 100, the fuel 110 may be substantially protected from liquid and solid contaminants. This may facilitate transporting the associated vehicle 102 with the nozzle assembly 100 attached without contaminating the fuel 110. The nozzle plug 112 may also facilitate initiating combustion of the fuel 110 in the vehicle 102 in environments that are conventionally difficult, such as during storms, on platforms in a body of water, on a ship, underground, or under water.

After the combustion process is initiated, the pressure from the exhaust may dislodge the nozzle plug 112 from the exit cone 104 of the nozzle assembly 100 and eject the nozzle plug 112 from the nozzle assembly 100. The nozzle plug 112 may be formed from a relatively light weight material, such as a polymer material (e.g., polytetrafluoroethylene (PTFE), polystyrene, polypropylene, polyvinyl chloride, etc.), a rubber material (e.g., ethylene propylene diene monomer (EPDM) rubber, latex, vulcanized rubber, etc.), a lightweight metal (e.g., aluminum, titanium, beryllium, etc.), or a composite material (e.g., carbon fiber, fiber glass, etc.).

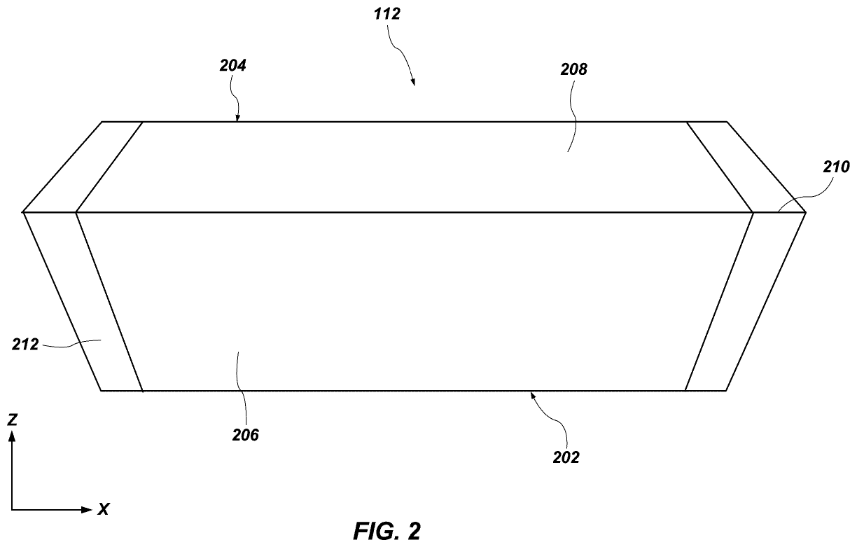

FIG. 2 illustrates an enlarged view of the nozzle plug 112. As discussed above, the nozzle plug 112 may have a complementary shape to the shape of the exit cone 104 of the nozzle assembly 100. For example, the nozzle plug 112 may have a frustoconical shape, having similar dimensions to at least a portion of the inner surface of the exit cone 104 of the nozzle assembly 100. The nozzle plug 112 extends between an inner end 202 and an outer end 204. The inner end 202 may be configured to be positioned proximate the throat 106 of the nozzle assembly 100 and the outer end 204 may be configured to be proximate the opening 108 of the nozzle assembly 100. Thus, the outer end 204 may be configured to be in contact with the surrounding environment.

In some embodiments, the nozzle plug 112 forms a single frustoconical shape extending from the inner end 202 to the outer end 204. Thus, the diameter of a cross-section of the nozzle plug 112 may gradually increase as the vertical distance (e.g., in the Z-direction) from the cross-section to the inner end 202 increases, with the diameter continuing to increase until the outer end 204. In other embodiments, such as the embodiment illustrated in FIG. 2, the nozzle plug 112 may form multiple sequential frustoconical shapes. For example, in the embodiment illustrated in FIG. 2, the nozzle plug 112 includes an sealing section 206 forming a first frustoconical shape increasing in diameter as it extends vertically (e.g., in the Z-direction) from the inner end 202 and a supporting section 208 forming a second frustoconical shape decreasing in diameter as it extends vertically from the inner end 202. The sealing section 206 and the supporting section 208 meet at a seam 210 where the sealing section 206 transitions to the supporting section 208. As discussed above, some embodiments of the nozzle plug 112 may only include the sealing section 206.

An outer surface of the sealing section 206 may form a seating surface 212. The seating surface 212 may be configured to seat against an inner surface of the exit cone 104 (FIG. 1) of the nozzle assembly 100 (FIG. 1). The seating surface 212 may be configured to form a liquid tight seal between the seating surface 212 and the inner surface of the exit cone 104 (FIG. 1), thus liquid or debris are substantially prevented from passing between the seating surface 212 and the inner surface of the exit cone 104 (FIG. 1). In some embodiments, the seal formed between the seating surface 212 and the inner surface of the exit cone 104 (FIG. 1) may be substantially gas tight, such that air and other gasses are substantially prevented from passing between the seating surface 212 and the inner surface of the exit cone 104 (FIG. 1) as well. Thus, the nozzle plug 112 may be configured to direct all materials, such as fluids (e.g., gas, liquid, solid) and debris, toward the outer end 204 of the nozzle plug 112, the outer end 204 and inner portions of the nozzle plug 112, may include structures configured to substantially block liquids and solids from passing through the nozzle plug 112.

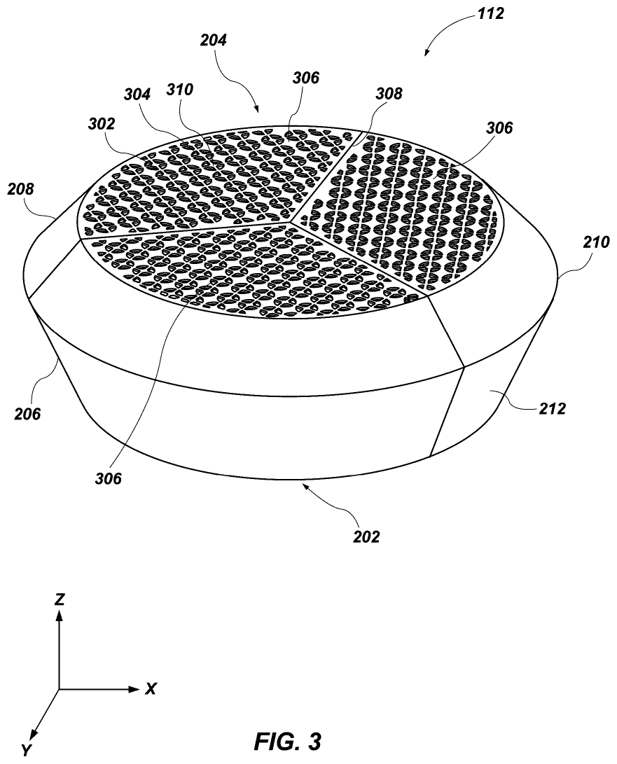

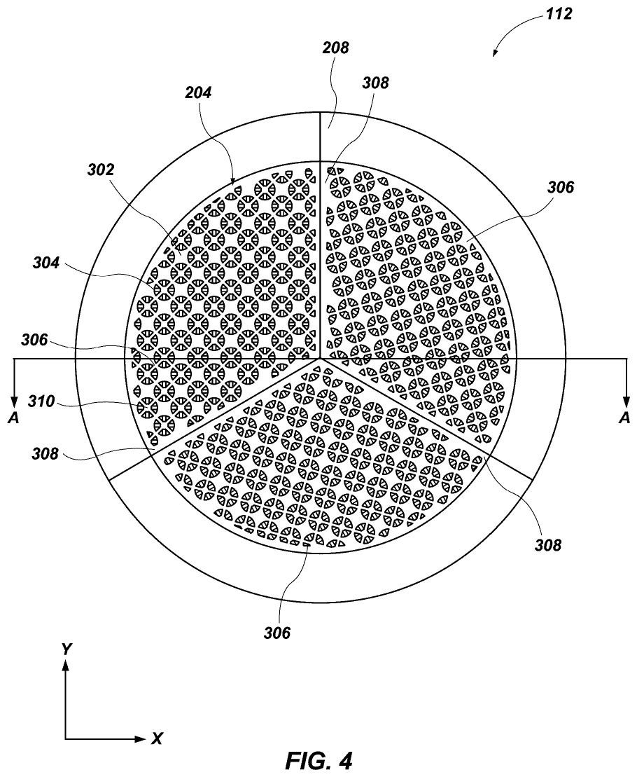

FIGS. 3 and 4 illustrate views of the outer end 204 of the nozzle plug 112. FIG. 3 is a perspective view of the nozzle plug 112 showing an outer face 302 of the nozzle plug 112 at the outer end 204 of the nozzle plug 112. FIG. 4 is a top-down view of the outer end 204 of the nozzle plug 112 showing the outer face 302 of the nozzle plug 112. The outer face 302 may include multiple open areas 304 defined in the outer face 302.

The open areas 304 may be sized and configured to substantially prevent contaminants from passing through the outer face 302 and into the nozzle plug 112. For example, the open areas 304 may have a size and shape configured to maintain surface tension in a liquid, such as water, that is likely to be encountered by the nozzle plug 112. The open areas 304 may also substantially prevent larger debris from passing through the outer face 302. For example, the open areas 304 may have a major dimension (e.g., width, length, diameter, apothem, etc.) that is less than about 0.25 in (less than about 6.35 mm), such as in a range from about 0.05 in (about 1.27 mm) to about 0.25 in (about 6.35 mm) or from about 0.05 in (about 1.27 mm) to about 0.2 in (about 5.08 mm) or about 0.1 in (about 2.54 mm).

The open areas 304 may be arranged in a pattern across the outer face 302. For example, the open areas 304 may be arranged in rows and columns extending laterally in the X and Y directions across the outer face 302. The outer face 302 may be divided into segments 306. In the embodiment illustrated in FIGS. 3 and 4, the outer face 302 is divided into three substantially equally sized segments 306 by separation structures 308. In other embodiments, the outer face 302 may be divided into two segments 306, four segments 306, five segments 306, and so on.

In the embodiment illustrated in FIGS. 3 and 4, the open areas 304 are each formed by a relatively large circular opening that is subdivided by lattice structures 310 extending from a center of each circular opening. Thus, the open areas 304 may be subdivisions of a larger opening, such as four subdivisions of a larger circular opening, as illustrated in FIGS. 3 and 4. In other embodiments, the open areas 304 may be a smaller or larger number of subdivisions of a larger opening, such as two subdivisions of a larger opening, three subdivisions of a larger opening, five subdivisions of a larger opening, etc.

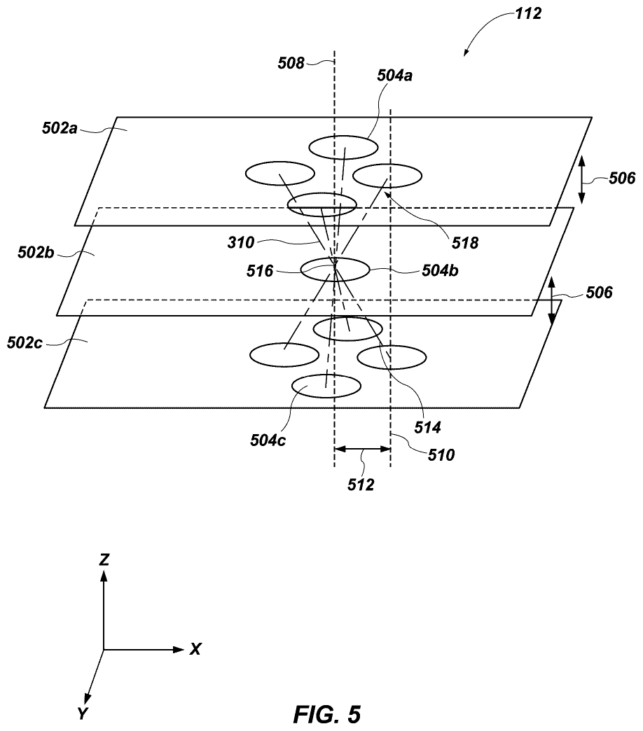

The nozzle plug 112 may include multiple lateral structures 502a, 502b, 502c similar to the outer face 302 disposed within the nozzle plug 112. FIG. 5 illustrates a simplified schematic of three lateral structures 502a, 502b, 502c and a relationship between openings 504a, 504b, 504c in each of the lateral structures 502a, 502b, 502c. For clarity and simplicity, a single set of openings 504a, 504b, 504c are illustrated. Each of the lateral structures 502a, 502b, 502c will include a pattern including multiple openings 504a, 504b, 504c across the associated lateral structures 502a, 502b, 502c with similar positional relationships to those illustrated in the single set of openings 504a, 504b, 504c, for example each of the lateral structures 502a, 502b, 502c may have a pattern of openings 504a, 504b, 504c similar to what is illustrated in the outer face 302 of FIGS. 3 and 4.

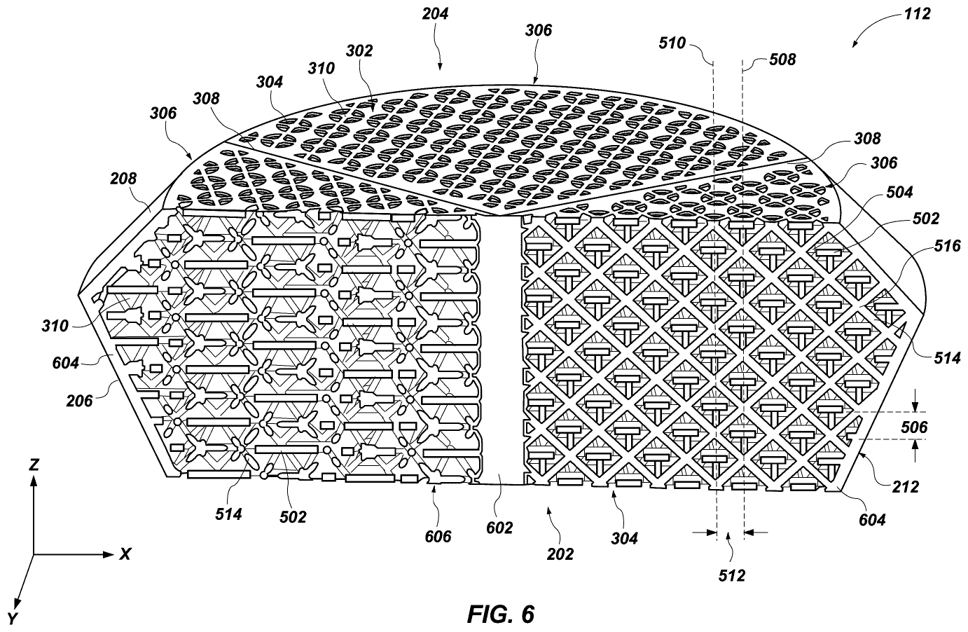

The lateral structures 502a, 502b, 502c include an upper lateral structure 502a, a lower lateral structure 502c and an intermediate lateral structure 502b. Each of the upper lateral structure 502a, the intermediate lateral structure 502b, and the lower lateral structure 502c may be adjacent to one another, such that no other lateral structures 502a, 502b, 502c are positioned vertically between the intermediate lateral structure 502b and the upper lateral structure 502a or the lower lateral structure 502c. Each of the upper lateral structure 502a, the intermediate lateral structure 502b, and the lower lateral structure 502c are vertically spaced by a gap 506. The gap may be in a range from about 0.1 in (about 2.54 mm) to about 0.5 in (about 12.7 mm), such as in a range from about 0.1 in (about 2.54 mm) to about 0.4 in (about 10.16 mm) or about 0.2 in (about 5.08 mm). In some embodiments, the gaps 506 between the lateral structures 502 a, 502 b, 502c are substantially uniform. In other embodiments, the gaps 506 between different lateral structures 502a, 502b, 502c may be different, such that some of the lateral structures 502a, 502b, 502c are closer together than others of the lateral structure 502a, 502b, 502c. While FIG. 5 illustrates three lateral structures 502a, 502b, 502c, additional lateral structures 502 may be present, as shown in FIG. 6.

The openings 504a, 504b, 504c in each of the lateral structures 502a, 502b, 502c may be laterally offset from the openings 504a, 504b, 504c in an adjacent lateral structure 502a, 502b, 502c. In the embodiment illustrated in FIG. 5, the openings 504b in the intermediate lateral structure 502b are laterally offset from the openings 504a, 504c in the upper lateral structure 502a and the lower lateral structure 502c. Offsetting the openings 504a, 504b, 504c in adjacent lateral structures 502a, 502b, 502c may facilitate increased filtering efficiency. For example, debris or liquid passing through an opening 504a in the upper lateral structure 502a may land on a portion of the intermediate lateral structure 502b between openings 504b in the intermediate lateral structure 502b. Similarly, debris or liquid passing through the opening 504b in the intermediate lateral structure 502b may contact a portion of the lower lateral structure 502c between the openings 504c in the lower lateral structure 502c.

The offset between the openings 504a, 504b, 504c in the adjacent lateral structures 502a, 502b, 502c by be defined by an offset distance 512 between a centerline 508 of an opening 504a, 504b, 504c in one of the lateral structures 502a, 502b, 502c to a centerline 510 of another opening 504a, 504b, 504c in an adjacent lateral structure 502a, 502b, 502c. In the embodiment illustrated in FIG. 5, the offset distance 512 is illustrated between the centerline 508 of the opening 504b in the intermediate lateral structure 502b and the centerline 510 of one of the openings 504c in the lower lateral structure 502c. A similar offset distance 512 may be defined between the centerline 508 of the opening 504b in the intermediate lateral structure 502b and the centerline 510 of any of the openings 504a, 504c in the upper lateral structure 502a or the lower lateral structure 502 c. The offset distance 512 may be in a range from about 0.1 in (about 2.54 mm) to about 0.5 in (about 12.7 mm), such as in a range from about 0.1 in (about 2.54 mm) to about 0.4 in (about 10.16 mm) or about 0.2 in (about 5.08 mm). In some embodiments, the offset distance 512 is substantially the same as the gap 506 between the adjacent lateral structures 502a, 502b, 502c.

As discussed above, the nozzle plug 112 may include the lattice structure 310 extending through the nozzle plug 112 as well. The lattice structure 310 may be formed from multiple lattice trusses 514 extending between the openings 504a, 504b, 504c in the different lateral structures 502a, 502b, 502c. The lattice trusses 514 may each extend in a substantially straight line between the centerlines 508, 510 of the adjacent openings 504a, 504b, 504c. The lattice structure 310 may be formed from multiple lattice trusses 514 intersecting at different intersections 516. The lattice structure 310 provides rigidity and mechanical strength to the nozzle plug 112.

In the embodiment illustrated in FIG. 5, the lattice structure 310 associated with the opening 504b in the intermediate lateral structure 502b is shown. The lattice structure 310 includes four lattice trusses 514. Each of the four lattice trusses 514 extend between the openings 504a in the upper lateral structure 502a and the openings 504c in the lower lateral structure 502c in substantially linear paths through the opening 504b in the intermediate lateral structure 502b. Each of the lattice trusses 514 pass through the centerlines 508, 510 of the associated openings 504a, 504b, 504c, such that each of the lattice trusses 514 form an intersection 516 at the centerline 508 of the opening 504b in the intermediate lateral structure 502b. As discussed above, FIG. 5 illustrates a single set of openings 504a, 504b, 504c. When expanded to include a pattern including multiple openings 504a, 504b, 504c across each of the associated lateral structures 502a, 502b, 502c, the lattice structure 310 would include multiple additional lattice trusses 514 forming similar intersections 516 at the centerlines 508, 510 of each of the openings 504a, 504b, 504c.

In the embodiment illustrated in FIG. 5, the upper lateral structure 502a and the lower lateral structure 502c each include four openings 504a, 504c associated with the opening 504b in the intermediate lateral structure 502b. Therefore, the lattice structure 310 includes four intersecting lattice trusses 514. In other embodiments, the upper lateral structure 502a and the lower lateral structure 502c may include a different number of openings 504a, 504c associated with the opening 504b in the lateral structure 502b, such as three openings 504a, 504c, five openings 504a, 504c, etc., such that the lattice structure 310 may be formed from a different number of lattice trusses 514 intersecting in the intersections 516, such as three lattice trusses 514 or five lattice trusses 514 at each intersection 516.

Each of the lattice trusses 514 may have a thickness, such that where the lattice trusses 514 meet at the intersection 516, the lattice truss 514 may extend from the centerline 508 to the periphery of the associated opening 504a, 504b, 504c. Thus, the lattice trusses 514 may combine to subdivide the openings 504a, 504b, 504c as illustrated in FIGS. 3 and 4. The thicknesses of the lattice trusses 514 may combine with the size of the openings 504a, 504b, 504c to define the size of the open area defined by each of the openings 504a, 504b, 504c. Smaller open areas may increase the successful filtration of contaminants while also decreasing the amount of air and other gasses that can pass through each of the lateral structures 502a, 502b, 502c. Similarly, increasing the size of the open areas may increase the amount of contaminants that may pass through the openings 504a, 504b, 504c but may also increase the amount of air and other gasses that can pass through each of the lateral structures 502a, 502b, 502c. The volume of the open areas may also contribute to the low weight of the nozzle plug 112.

In some embodiments, the thickness of the lattice trusses 514 may change throughout the nozzle plug 112, such that the open area in some of the lateral structures 502a, 502b, 502c is different than the open area in other lateral structures 502a, 502b, 502c. For example, the lattice trusses 514 may have a greater thickness proximate the inner end 202 (FIG. 2) of the nozzle plug 112 than the thickness of the lattice trusses 514 proximate the outer end 204 (FIG. 2) of the nozzle plug 112. Thus, the open area defined by the openings 504a, 504b, 504c in a lateral structure 502a, 502b, 502c proximate the inner end 202 (FIG. 2) of the nozzle plug 112 may be smaller than the open area defined by the openings 504a, 504b, 504c defined in a lateral structure 502a, 502b, 502c proximate the outer end 204 (FIG. 2) of the nozzle plug 112.

The lattice trusses 514 may each extend through the associated centerlines 508, 510 at an angle 518. Because the lattice trusses 514 are substantially linear, the angles 518 between the lattice trusses 514 and each of the associated centerlines 508, 510 may be substantially the same. The angle 518 may be in a range from about 30 degrees to about 60 degrees, such as about 45 degrees. In embodiments where the offset distance 512 between openings 504a, 504b, 504c in adjacent lateral structures 502a, 502b, 502c is substantially the same as the gap 506 between the adjacent lateral structures 502 a, 502 b, 502 c, the angles 518 may be about 45 degrees. The angles 518 of the lattice trusses 514 may be sufficient to direct liquids in the nozzle plug 112 along the lattice trusses 514. This may facilitate the formation of pools of the liquids through surface tension that may substantially prevent the liquids from passing through the next opening 504a, 504b, 504c associated with the lattice truss 514.

In some embodiments, the surface roughness of the lateral structures 502a, 502b, 502c and/or the lattice trusses 514 may be controlled to facilitate the formation of pools of liquid materials as well. For example, the lateral structures 502a, 502b, 502c may have an RA surface roughness in a range from about 3 μm to about 12 μm.

FIG. 6 illustrates a cross-sectional view of the nozzle plug 112. The nozzle plug 112 is formed from multiple lateral structures 502 vertically spaced throughout the nozzle plug 112. The lateral structures 502 are each spaced by the gap 506 (e.g., a vertical gap). The vertical gaps 506 between the lateral structures 502 may be substantially uniform throughout the nozzle plug 112, such that each lateral structure 502 is spaced from the adjacent lateral structures 502 by substantially the same gap 506.

Each lateral structure 502 includes multiple openings 504 distributed about a single lateral structure 502. The openings 504 may form a uniform pattern through at least a portion of each lateral structure 502. For example, each lateral structure 502 may be divided into segments 306 as discussed above, the openings 504 may be arranged in substantially uniform patterns (e.g., having uniform spacing in both an X-direction and a Y-direction) through each segment 306 of each lateral structure 502.

As discussed above, each of the segments 306 are separated by separation structures 308. The separation structures 308 may extend vertically through the nozzle plug 112, such that each of the lateral structures 502 are vertically connected through the separation structures 308. Thus, the separation structures 308 may be configured to maintain the gaps 506 between the lateral structures 502. Each of the separation structures 308 may meet at a central separation structure 602 extending vertically through a central region of the nozzle plug 112. As illustrated in FIG. 6, the central separation structure 602 may be substantially solid (e.g., substantially free of openings). The other separation structures 308 may also be substantially solid. Thus, no fluids (e.g., liquid or gas) may pass between the segments 306 through the separation structures 308 or the central separation structure 602. Similarly, outer walls 604 of the nozzle plug 112 that may form the seating surface 212 of the sealing section 206 of the nozzle plug 112 and the outer surface of the supporting section 208 of the nozzle plug 112 may be substantially solid, such that no fluids may pass through the outer walls 604 of the nozzle plug 112. Thus, the lattice structure 310 and the lateral structures 502 of the nozzle plug 112 are configured to control the passage of all fluids between the outer end 204 of the nozzle plug 112 and the inner end 202 of the nozzle plug 112.

As discussed above, the openings 504 in adjacent lateral structures 502 are laterally offset by an offset distance 512 measured between the centerlines 508, 510 of the openings 504. The offset distances 512 throughout the nozzle plug 112 are uniform, such that the openings 504 in a first lateral structure 502 are laterally offset from the openings 504 in a second lateral structure 502 by the same offset distance 512 as openings 504 in a third lateral structure 502 are laterally offset from the openings 504 in the second lateral structure 502. The uniform offset distances 512 throughout the nozzle plug 112 may result in a linear relationship between the openings 504 of the different lateral structures 502. For example, a center point of each opening 504 may be substantially aligned with the center points of openings 504 in adjacent lateral structures 502 at an angle substantially the same as the angle of the lattice trusses 514. The lattice trusses 514 may be arranged such that the lattice trusses 514 pass through the center point of an opening 504 at each lateral structure 502. The lattice structure 310 may be formed from multiple lattice trusses 514 extending in different directions through the nozzle plug 112 that intersect one another at the intersection 516 at the center points of the associated openings 504. As illustrated in FIG. 6, some of the lattice trusses 514 may extend in a Z-X plane. Other lattice trusses 514 may extend in a Z-Y plane. Other lattice trusses 514 may extend in a plane defined by the Z-axis and a line extending between the X axis and the Y axis.

The lattice structure 310 may be configured to support the lateral structures 502 and maintain the gaps 506 between the lateral structures 502. In some embodiments, the lattice structure 310 is configured to increase a rigidity of the nozzle plug 112. In some embodiments, the lattice structure 310 is configured to direct fluid flow through the nozzle plug 112. For example, liquids that pass through the open areas 304 in the outer face 302, may be directed to the lateral structure 502 directly below the outer face 302 by one or more of the lattice trusses 514 of the lattice structure 310. If any liquid passes through, the liquid may be proximal to the outer end 204. Surface tension in the liquid may cause the liquid to adhere to the associated lattice trusses 514. The surface tension may also cause the liquid that reaches the next lateral structure 502 to pool on the lateral structure 502 instead of flowing through another open area 304 defined in the lateral structure 502. Any liquid that passes through an open area 304 in the lateral structure 502 may again be directed by the lattice trusses 514 to the next lateral structure 502. Thus, the amount of liquid passing through the nozzle plug 112 may be reduced at each subsequent lateral structure 502 by pooling caused by the surface tension of the liquid until the amount of liquid passing through each lateral structure 502 is substantially eliminated. Therefore, little or no liquid is present proximal to the inner end 202.

In some embodiments, as discussed above, with respect to FIG. 5, the open areas 304 in subsequent lateral structures 502 may gradually be reduced, such as by increasing a thickness of the lattice trusses 514 passing through the associated openings 504. The reduction in the size of the open areas 304 may further decrease the amount of liquid passing through the open areas 304 in each subsequent lateral structure 502. Thus, the liquid passing through the nozzle plug 112 to the inner end 202 may be substantially reduced or eliminated.

Each lateral structure 502 including the lateral structure 502 forming an inner face 606 may include the open areas 304. The inclusion of the open areas 304 through each lateral structure 502 of the nozzle plug 112 may facilitate the passage of gasses, such as air, through the nozzle plug 112, which may facilitate pressure distribution and eventual equalization across the nozzle plug 112. Increasing the pressure distribution and equalization across the nozzle plug 112 may reduce pressure induced damage to the associated nozzle assembly 100 (FIG. 1) from sudden increases in external pressure, such as during a launch sequence. In some embodiments, at least some of the structures of the nozzle plug 112 are formed from a flexible material, such as a polymer or rubber that may be configured to absorb some of the shock from a sudden increase in external pressure to further prevent damage to the associated nozzle assembly 100 (FIG. 1) from the nozzle plug 112. In other embodiments, at least some of the structures of the nozzle plug 112 are formed from a lightweight metal if additional strength of the nozzle plug 112 is desired. In some embodiments, the nozzle plug 112 may be formed from multiple different materials. For example, the lateral structures 502 may be formed from a lightweight metal material and the lattice structure 310 may be formed from a flexible material. In some embodiments, different portions of the lattice structure 310 may be formed from different materials. For example, the lattice structure 310 proximate the inner end 202 may be formed from a lightweight metal material and the lattice structure 310 proximate the outer end 204 may be formed from a flexible material or vice versa.

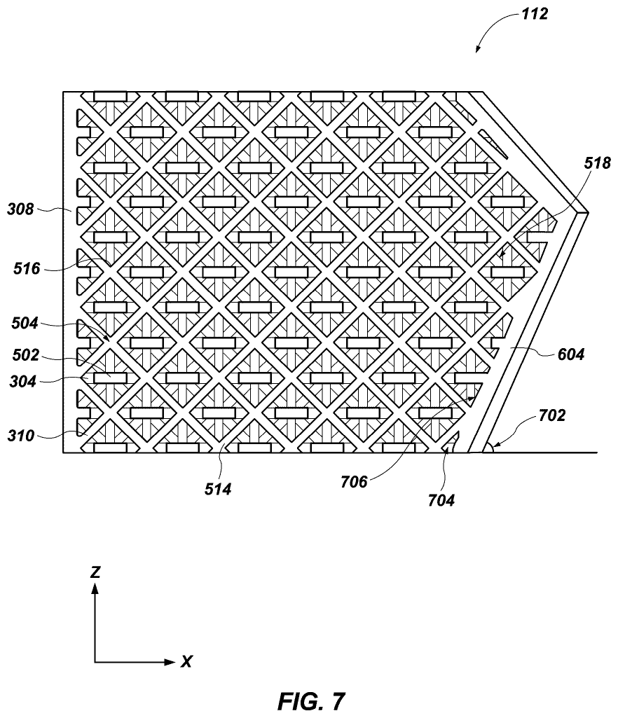

FIG. 7 illustrates an enlarged view of a portion of the cross-section illustrated in FIG. 6. As discussed above, each lateral structure 502 may be separated into segments 306 bounded by separation structures 308 and the outer wall 604 of the nozzle plug 112. As discussed above, a portion of the nozzle plug 112 may have a frustoconical shape complementary to an inner surface of the exit cone 104 (FIG. 1) of the nozzle assembly 100 (FIG. 1). Therefore, the outer wall 604 may extend at an angle 702 relative to the lateral structures 502 that is substantially similar to an angle of the exit cone 104 (FIG. 1) of the associated nozzle assembly 100 (FIG. 1). The angle 702 of the outer wall 604 relative to the lateral structures 502 may be in a range from about 45 degrees to about 90 degrees, such as from about 50 degrees to about 70 degrees.

As discussed above, the lattice trusses 514 of the lattice structure 310 extend at an angle 518 relative to the lateral structures 502. The angle 518 of the lattice trusses 514 relative to the lateral structures 502 may be less than the angle 702 of the outer wall 604 relative to the lateral structures 502. Therefore, the lattice trusses 514 may intersect the outer wall 604 at an angle 704. The angle 704 of the lattice trusses 514 relative to the outer wall 604 may be in a range from about 10 degrees to about 30 degrees.

The smaller angle of the lattice trusses 514 relative to the lateral structures 502 may be configured to maintain surface tension in liquids passing through the nozzle plug 112, such that the lattice trusses 514 may facilitate pooling of the liquids at the intersections 516 and on the associated lateral structures 502. The lattice trusses 514 intersecting with the outer wall 604 may also be configured to intercept liquid or other contaminants on the inner surface 706 of the outer wall 604 that extends at the larger angle 702 and transition the liquid or other contaminants to the smaller angled interfaces of the lattice trusses 514 to facilitate increased pooling and reduce the amount of liquid or contaminants passing through the subsequent lateral structures 502.

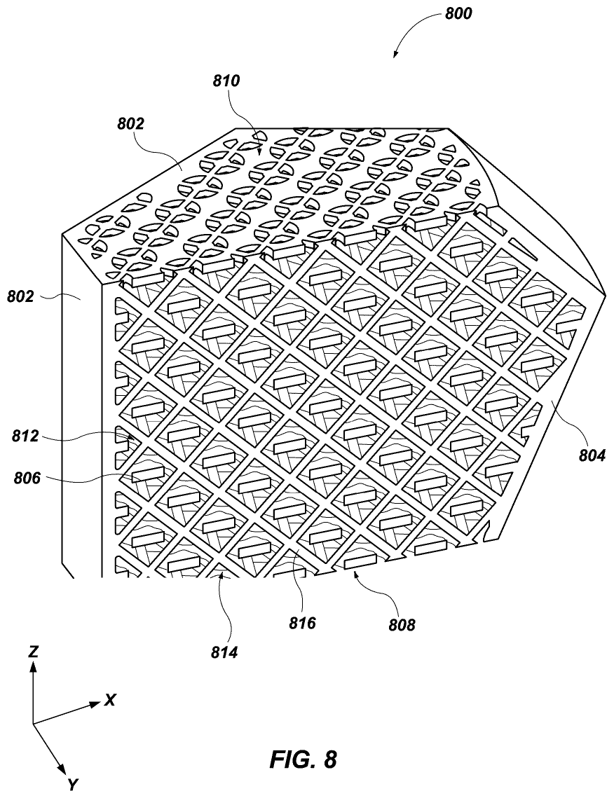

In some embodiments, a nozzle plug, such as the nozzle plug 112 illustrated in FIGS. 1-7 may be formed from multiple different pieces assembled to form the complete nozzle plug. FIG. 8 illustrates a cross-section of a perspective view of a segment 800 of such a nozzle plug. The segment 800 may be bounded by boundary walls 802 and an outer wall 804. The outer wall 804 may be configured to form an outer surface of the nozzle plug, such as a seating surface and/or an outer surface in a supporting section of the nozzle plug. The boundary walls 802 may be configured to abut against boundary walls 802 of adjacent segments 800 when the segments 800 are assembled into a complete nozzle plug.

The segment 800 may include multiple lateral structures 806 vertically spaced throughout the segment 800 and forming an inner face 808 and an outer face 810 of the segment 800. The inner face 808 and the outer face 810 may form vertical boundaries of the segment 800 and the nozzle plug when assembled. The lateral structures 806 may each include multiple openings 812 defined in the lateral structures 806 as discussed above. The openings 812 may be arranged in substantially uniform patterns across each of the lateral structures 806. The openings 812 in adjacent lateral structures 806 may be laterally offset from one another, such that centerlines of the openings 812 in a first lateral structure 806 are not aligned with the centerlines of the openings 812 in a second adjacent lateral structure 806.

A lattice structure 814 may be formed throughout the segment 800 by lattice trusses 816 that intersect at the center points of the openings 812 in each of the lateral structures 806. Each opening 812 may be intersected by three or more lattice trusses 816, such as four lattice trusses 816, five lattice trusses 816, etc. As noted above, the lattice trusses 816 may have a uniform thickness throughout the segment 800. In other embodiments, the lattice trusses 816 may have changing thicknesses throughout the segment 800, such that the lattice trusses 816 have a greater thickness proximate the inner face 808 and a reduced thickness proximate the outer face 810. The changing thicknesses of the lattice trusses 816 may define a graduated change in a size of the open areas defined by the openings 812 and the lattice trusses 816, such that the open areas in the inner face 808 are smaller than the open areas in the outer face 810.

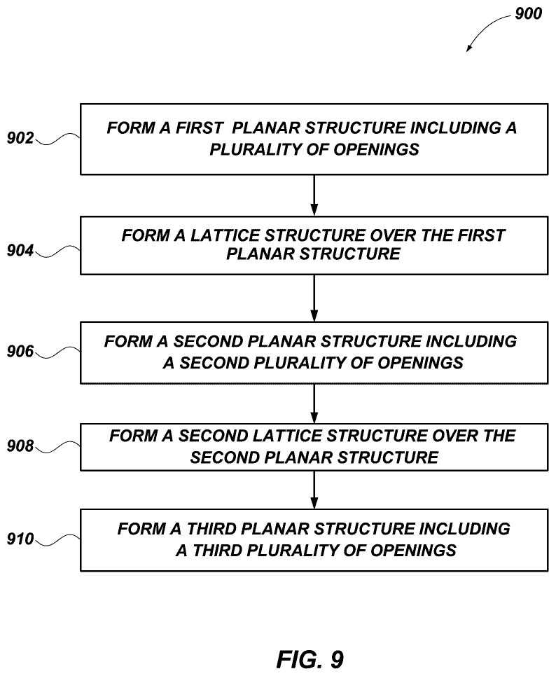

FIG. 9 illustrates a flow chart representative of a method 900 of forming a nozzle plug (e.g., nozzle plug 112) or segment of a nozzle plug (e.g., segment 800) as illustrated in FIGS. 1-8. The nozzle plug or segment of the nozzle plug may be formed through an additive manufacturing process, such as 3-D printing, where material is built up layer by layer to form a complex three-dimensional shape. Additive manufacturing may facilitate the formation of complex internal structures, such as the lattice structures (e.g., lattice structures 310, 814). Thus, additive manufacturing may facilitate greater precision in the formation of internal structures of the nozzle plug.

A first planar structure may be formed in act 902. The first planar structure may include multiple openings defined through the first planar structure. The openings may be arranged in substantially uniform rows and columns. For example, each of the openings may have a substantially uniform size and shape and the spacing between adjacent openings may be substantially uniform in both an X-direction and a Y-direction, such that the spacing between rows of openings and columns of openings across the first planar structure are substantially uniform. The first planar structure may be formed to have a surface roughness sufficient to facilitate pooling of a liquid material on the surface of the first planar structure. For example, the first planar structure may have an RA surface roughness greater than about 6 μm.

In some embodiments, the first planar structure is formed through an additive manufacturing process by forming one or more planar layers having openings that are substantially free of the material used to form the first planar structure. In other embodiments, the first planar structure may be formed through another manufacturing process, such as machining or molding. The first planar structure may be formed from a light weight material, such as a polymer (e.g., polytetrafluoroethylene (PTFE), polystyrene, polypropylene, polyvinyl chloride, etc.), a rubber material (e.g., ethylene propylene diene monomer (EPDM) rubber, latex, vulcanized rubber, etc.), a lightweight metal (e.g., aluminum, titanium, beryllium, etc.), or a composite material (e.g., carbon fiber, fiber glass, etc.).

After forming the first planar structure in act 902, a lattice structure (e.g., lattice structure 310, 814) may be formed over the first planar structure in act 904. The lattice structure may be formed as multiple lattice trusses. As discussed above, each of the lattice trusses may extend from a center point of an opening of the openings formed in the first planar structure. There may be multiple lattice trusses associated with each opening. For example, each opening may include at least three lattice trusses extending from the center point of the opening, such as at least four lattice trusses or at least five lattice trusses. The lattice trusses may be formed to extend at substantially a same angle relative to the first planar structure and in different lateral directions. For example, the lattice trusses may each extend at an angle of between about 30 degrees and about 60 degrees, such as about 45 degrees relative to the first planar structure. At least one of the lattice trusses may extend in a vertical ZX plane and another of the lattice trusses may extend in a vertical ZY plane. In some embodiments, the lattice trusses may extend in other vertical planes defined by a Z axis and a line extending between the X axis and the Y axis.

The lattice structure may be formed through an additive manufacturing process by applying multiple layers of material to build up the individual lattice trusses until a lattice structure is formed over the first planar structure. The lattice structure may be formed from a light weight material, such as a polymer (e.g., polytetrafluoroethylene (PTFE), polystyrene, polypropylene, polyvinyl chloride, etc.), a rubber material (e.g., ethylene propylene diene monomer (EPDM) rubber, latex, vulcanized rubber, etc.), a lightweight metal (e.g., aluminum, titanium, beryllium, etc.), or a composite material (e.g., carbon fiber, fiber glass, etc.). In some embodiments, the lattice structure is formed from the same material as the first planar structure. In other embodiments, the lattice structure is formed from a different lightweight material as the first planar structure.

The lattice trusses may be built up until the lattice trusses intersect one another at a point above the first planar structure. After the lattice trusses intersect one another at the point above the first planar structure, a second planar structure may be formed in act 906. The second planar structure may be formed to include openings defined through the second planar structure. The openings in the second planar structure may be positioned such that the intersections of the lattice trusses are positioned at the center points of the openings in the second planar structure. The openings in the second planar structure may be laterally offset from the openings in the first planar structure, such that centerlines passing through the openings in the second planar structure are parallel to and laterally offset from centerlines passing through the openings in the first planar structure.

The second planar structure may be formed to be substantially parallel to the first planar structure and vertically offset from the first planar structure. The vertical offset distance may be defined by the lattice structure. For example, the vertical distance between the intersections of the lattice trusses may be the same as the vertical offset distance between the first planar structure and the second planar structure, such that the first planar structure is aligned with a first set of intersections of the lattice trusses and the second planar structure is aligned with a second set of intersections of the lattice trusses.

The second planar structure may be formed to have a surface roughness sufficient to facilitate pooling of a liquid material on the surface of the second planar structure. For example, the second planar structure may have an RA surface roughness greater than about 6 μm.

In some embodiments, the second planar structure is formed through an additive manufacturing process by forming one or more planar layers having openings that are substantially free of the material used to form the second planar structure. The second planar structure may be formed from a light weight material, such as a polymer (e.g., polytetrafluoroethylene (PTFE), polystyrene, polypropylene, polyvinyl chloride, etc.), a rubber material (e.g., ethylene propylene diene monomer (EPDM) rubber, latex, vulcanized rubber, etc.), a lightweight metal (e.g., aluminum, titanium, beryllium, etc.), or a composite material (e.g., carbon fiber, fiber glass, etc.). In some embodiments, the second planar structure is formed from the same material as the first planar structure. In other embodiments, the second planar structure is formed from a different lightweight material as the first planar structure.

After forming the second planar structure in act 906, a second lattice structure (e.g., lattice structure 310, 814) may be formed over the second planar structure in act 908. The second lattice structure may be formed as a continuation of the multiple lattice trusses extending from the center points of the openings formed in the first planar structure that intersect the center points of the openings in the second planar structure. Thus, the second lattice structure may extend from the center points of the openings in the second planar structure.

The lattice structure may be formed through an additive manufacturing process by applying multiple layers of material to build up the individual lattice trusses until a lattice structure is formed over the second planar structure. The lattice structure may continue to be formed from a light-weight material, such as a polymer (e.g., polytetrafluoroethylene (PTFE), polystyrene, polypropylene, polyvinyl chloride, etc.), a rubber material (e.g., ethylene propylene diene monomer (EPDM) rubber, latex, vulcanized rubber, etc.), a lightweight metal (e.g., aluminum, titanium, beryllium, etc.), or a composite material (e.g., carbon fiber, fiber glass, etc.).

The lattice trusses may be built up until the lattice trusses intersect one another at a point above the second planar structure. After the lattice trusses intersect one another at the point above the second planar structure, a third planar structure may be formed in act 910. The third planar structure may be formed to include openings defined through the second planar structure. The openings in the third planar structure may be positioned such that the intersections of the lattice trusses are positioned at the center points of the openings in the third planar structure. The openings in the third planar structure may be laterally offset from the openings in the second planar structure, such that centerlines passing through the openings in the third planar structure are parallel to and laterally offset from centerlines passing through the openings in the second planar structure. In some embodiments, the openings in the third planar structure are laterally aligned with the openings in the first planar structure. Thus, the openings in adjacent planar structures may be laterally offset from one another while the openings in every other planar structure may be laterally aligned with one another.

The third planar structure may be formed to be substantially parallel to the first planar structure and the second planar structure and vertically offset from the first planar structure and the second planar structure. The vertical offset distance may be defined by the lattice structure. For example, the vertical distance between the intersections of the lattice trusses may be the same as the vertical offset distance between the second planar structure and the third planar structure, such that the second planar structure is aligned with a second set of intersections of the lattice trusses and the third planar structure is aligned with a third set of intersections of the lattice trusses. The vertical offset distance between the second planar structure and the third planar structure may be substantially the same as the vertical offset distance between the first planar structure and the second planar structure.

The third planar structure may be formed to have a surface roughness sufficient to facilitate pooling of a liquid material on the surface of the second planar structure. For example, the third planar structure may have an RA surface roughness greater than about 6 μm.

In some embodiments, the third planar structure is formed through an additive manufacturing process by forming one or more planar layers having openings that are substantially free of the material used to form the second planar structure. The second planar structure may be formed from a light weight material, such as a polymer (e.g., polytetrafluoroethylene (PTFE), polystyrene, polypropylene, polyvinyl chloride, etc.), a rubber material (e.g., ethylene propylene diene monomer (EPDM) rubber, latex, vulcanized rubber, etc.), a lightweight metal (e.g., aluminum, titanium, beryllium, etc.), or a composite material (e.g., carbon fiber, fiber glass, etc.). After forming the third planar structure the process may be repeated forming a pattern of additional lattice structures and planar structure to build up the entire nozzle plug or segment of the nozzle plug.

Embodiments of the disclosure may facilitate forming a nozzle plug that is light weight and is configured to control the passage of different fluids through the nozzle plug. Light weight nozzle plugs may be easier to handle for a user when loading the nozzle plug into the nozzle of a motor. Light weight nozzle plugs may also reduce or eliminate damage and/or injuries caused by the nozzle plug when ejected from an associated nozzle after initiating a combustion process in the associated motor. Additive manufacturing may be used to form the nozzle plug, enabling the lateral structures, the lattice structures, and the lattice trusses to be formed at relatively small and uniform sizes. Forming the nozzle plug by additive manufacturing also reduces the cost of the nozzle plug and the amount of time to form the nozzle plug, compared to methods of forming conventional nozzle plugs. By using additive manufacturing, the nozzle plugs may be easily formed having different configurations of the pattern of lattice structures, openings, and lattice trusses.

Embodiments of the disclosure may also facilitate improved control of the internal passages through the nozzle plug. Improved control of the passages through the nozzle plug may facilitate improved removing (e.g., filtering) of contaminants by the nozzle plug. Improving the filtering of the contaminants may improve the performance of the associated motor, such as by preventing contamination of the fuel and/or improving reliability of the combustion initiation process particularly in wet environments. Improved control of the passages through the nozzle may further facilitate a reduction in the pressure differential across the nozzle plug when a high outside pressure is experienced, such as when the associated motor is ejected from a tube through a high pressure ejection. The reduction in the pressure differential may reduce damage caused to the nozzle by the nozzle plug in high outside pressure conditions.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A nozzle plug comprising:
a first lateral structure in a first lateral plane, the first lateral structure comprising a first set of openings defined in the first lateral structure;
a second lateral structure in a second lateral plane vertically offset from and parallel to the first lateral plane, the second lateral structure comprising a second set of openings defined in the second lateral structure, the second set of openings laterally offset from the first set of openings; and
a lattice structure positioned between the first lateral plane and the second lateral plane.

2. The nozzle plug of claim 1, the lattice structure comprising lattice trusses extending between first individual openings of the first set of openings and second individual openings of the second set of openings.

3. The nozzle plug of claim 2, wherein the lattice trusses intersect at center points of the first individual openings.

4. The nozzle plug of claim 2, wherein the lattice trusses extend at an angle relative to the first lateral structure.

5. The nozzle plug of claim 4, wherein the angle is in a range from about 30 degrees to about 60 degrees.

6. The nozzle plug of claim 2, wherein the lattice trusses comprise at least three lattice trusses extending from a first center point of one opening of the first individual openings to second center points of at least three different second individual openings of the second individual openings.

7. The nozzle plug of claim 1, wherein the lattice structure, in combination with the first set of openings, defines a first set of open areas in the first lateral structure and the lattice structure, in combination with the second set of openings, defines a second set of open areas in the second lateral structure.

8. The nozzle plug of claim 7, wherein the first set of open areas is smaller than the second set of open areas.

9. The nozzle plug of claim 7, wherein each open area of the open areas has a major dimension in a range from about 0.05 in (about 1.27 mm) to about 0.25 in (about 6.35 mm).

10. The nozzle plug of claim 7, wherein the lattice structure comprises lattice trusses intersecting the first set of openings in the first lateral structure and the second set of openings in the second lateral structure, wherein a first intersection between the lattice trusses and the first set of openings define the first set of open areas and a second intersection between the lattice trusses and the second set of openings define the second set of open areas.

11. The nozzle plug of claim 10, wherein the lattice trusses have a first thickness at the first intersection and a second different thickness at the second intersection.

12. A method of forming a nozzle plug, the method comprising:
forming a first lateral structure comprising a first planar structure including a first plurality of openings defined in the first lateral structure;
forming a lattice structure over the first lateral structure, the lattice structure including lattice trusses extending at an angle relative to the first lateral structure, where each lattice truss extends from an opening of the first plurality of openings defined in the first lateral structure; and
forming a second lateral structure over the first lateral structure, the second lateral structure comprising a second planar structure including a second plurality of openings, wherein each opening of the second plurality of openings is joined to at least one lattice truss of the lattice trusses of the lattice structure.

13. The method of claim 12, wherein forming the lattice structure comprises forming the lattice trusses of the lattice structure through an additive manufacturing process.

14. The method of claim 12, wherein forming the second lateral structure comprises forming the second lateral structure including the second plurality of openings, wherein each opening of the second plurality of openings is laterally offset from each opening of the first plurality of openings, such that no opening of the first plurality of openings is laterally aligned with any opening of the second plurality of openings.

15. The method of claim 12, wherein forming the first lateral structure comprises forming a first surface of the first lateral structure to have an RA surface roughness greater than about 6 μm.

16. The method of claim 12, wherein forming the second lateral structure comprises forming the second plurality of openings in the second planar structure, such that a center point of each opening of the second plurality of openings is positioned on an intersection between the lattice trusses of the lattice structure.

17. A nozzle assembly comprising:
a nozzle exit cone; and
a nozzle plug disposed in the nozzle exit cone, the nozzle plug comprising:
a lattice structure comprising intersecting lattice trusses; and
a first lateral structure including a first plurality of openings defined in the lateral structure, each opening of the first plurality of openings in the lateral structure positioned at an intersection between at least two lattice trusses of the intersecting lattice trusses of the lattice structure.

18. The nozzle assembly of claim 17, further comprising a throat positioned on a first end of the nozzle exit cone and an opening positioned on a second end of the nozzle exit cone opposite the throat.

19. The nozzle assembly of claim 18, wherein the nozzle plug further comprises a second lateral structure, the second lateral structure comprising a second plurality of openings defined in the second lateral structure, each opening of the second plurality of openings in the second lateral structure positioned at second intersections between at least two additional lattice trusses of the intersecting lattice trusses of the lattice structure, wherein the lattice structure is positioned between the first lateral structure and the second lateral structure and the first lateral structure is positioned proximate the throat of the nozzle assembly and the second lateral structure is positioned proximate the opening of the nozzle assembly.

20. The nozzle assembly of claim 19, wherein the at least two lattice trusses of the intersecting lattice trusses at the intersection between the at least two lattice trusses of the intersecting lattice trusses of the lattice structure proximate the first lateral structure have a first thickness and the at least two additional lattice trusses at the second intersections between the at least two additional lattice trusses of the intersecting lattice trusses of the lattice structure proximate the second lateral structure have a second thickness less than the first thickness.
